(19) United States
(12) Patent Application Publication
(10) Pub. No.: US 2008/0166610 A1
(43) Pub. Date: Jul. 10, 2008

(54) POLYMER ELECTROLYTE FUEL CELL

(76) Inventors: Katsunori Nishimura, Hitachiota (JP); Hironori Sasaki, Tokai (JP); Kenji Yamaga, Hitachi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/923,780

(22) Filed: Oct. 25, 2007

(30) Foreign Application Priority Data
Oct. 25, 2006 (JP) 2006-289412

(51) Int. Cl. H01M 8/04; H01M 8/10

(52) U.S. Cl. 429/24; 429/30

(57) ABSTRACT

An object of the present invention is to provide a polymer electrolyte fuel cell capable of producing a high output without causing a drop or instability of the cell voltage of the fuel cell and a generating system having the polymer electrolyte fuel cell mounted thereon.

A fuel cell system, wherein if, in a polymer electrolyte fuel cell having a cell comprising separators sandwiching an electrolyte membrane and electrodes, a temperature (Tmax) at which a standard deviation of a cell voltage begins to increase when water content retained in the cell is increased under conditions under which a cell temperature, a gas entrance dew point, and a current are specified and the temperature (Tmin) at which an average value of the cell voltage begins to drop when the gas dew point is decreased under conditions under which the cell temperature, gas entrance dew point, and current are specified are defined, the water content retained in the cell satisfies: upper limit of a maximum amount of water retained in a cell≧water content retained in a cell≧lower limit of a maximum amount of water retained in a cell is provided.

### BACKGROUND OF THE INVENTION

1. Field of the Invention

The present invention relate to a startup time reduction or output characteristic stabilization of a polymer electrolyte fuel cell and a generating system having the polymer electrolyte fuel cell mounted thereon by preventing malfunctions such as instability of a voltage of the polymer electrolyte fuel cell and a voltage drop when the fuel cell starts up, electricity is generated steadily, or a load changes.

2. Description of the Related Art

Due to a high output, long life, less deterioration by startup/stop, low operating temperature (about 70 to 80° C.) and the like, a polymer electrolyte fuel cell has advantages such as ease of startup/stop. Therefore, wide-ranging uses such as a power supply for electric vehicles and a dispersed power supply for businesses and homes are expected.

Among such uses, a dispersed power supply (for example, a cogeneration generating system) in which polymer electrolyte fuel cells are mounted is a system that attempts to utilize energy efficiently by extracting electricity from the polymer electrolyte fuel cells and at the same time, recovering heat generated by the cells during electricity generation as hot water. Such a dispersed power supply is required to have a long life of 50,000 to 100,000 hours and the membrane-electrode assembly (MEA), cell structure, electricity generation conditions and the like are being improved.

To realize such a long life, stability of the voltage needs to be improved. The voltage of a cell is the sum of the voltage of each cell and thus, it is preferable that the voltage of each cell is stable. If the voltage of each cell becomes unstable, a main cause thereof is that waterdrops accumulate in a gas passage inside the cell and a blockade of the passage or flooding (wetting) on an electrode surface inhibits a hydrogen oxidization reaction or oxygen reduction reaction on the electrode.

If the aforementioned reaction inhibition occurs, an undesirable reaction such as catalyst dissolution and oxidization of a conducting material proceeds to the extent that a current fed by electricity generation to flow through each cell exceeds the amount of gas consumption. As a result, deterioration of the catalyst and an increase in contact resistance caused by oxidization of separators will occur, making the life of the cell shorter in the end. Therefore, prevention of such a passage blockade and flooding will be a technology required to realize a long life of the cell. As one of the solutions therefor, a separator resistant to a passage blockade is under development.

There is also a problem of malfunction in which the voltage becomes unstable due to water transiently stored in a cell after variations of the temperature or output of the cell not only during electricity generation at rated power output, but also during startup or load change. In this case, a side reaction caused by a passage blockade will oxidize or corrode material of, for example, the electrode catalyst and separators, making the cell life shorter.

As a means for circumventing these problems, steps by adjusting operating conditions by which the gas dew point is lowered can be considered.

However, simply lowering the gas dew point decreases the amount of water taken in a cell, decreasing the probability of occurrence of a passage blockade, but, on the other hand, adverse effects such as decreased water content of an electrolyte membrane, an output drop due to increased ionic resistance, and further a drop in cell life due to a gas cross via the electrolyte membrane may be caused.

The following Patent Document is known as a technology to correct parameters of the gas flow rate and coolant when the voltage becomes unstable.

[Patent Document 1] Japanese Patent Application Laid-Open No. 2004-322595

An object of the present invention is to provide a polymer electrolyte fuel cell capable of producing a high output without causing a drop or instability of the cell voltage of the fuel cell and a generating system having the polymer electrolyte fuel cell mounted thereon.

### SUMMARY OF THE INVENTION

The inventors have found, as a result of their analysis, that the following is needed to combine output with stability. In order to realize electricity generation in which output of a fuel cell is as high as possible, that is, the cell voltage is as high as possible and also a portion of the cell voltage does not become unstable during electricity generation, it is necessary to set a water content of an electrolyte membrane to an appropriate level or higher and also operating parameters of, for example, gas dew point to the extent that a passage blockade of a separator does not occur. To implement the above in a fuel cell system, an operating parameter controlling the water content inside the cell is found out and the operating parameter is set to the range of an operation map of the present invention. Details of a method thereof will be described below.

Voltage stability is controlled by presence/absence of a blockade due to accumulation of waterdrops in a separator passage. The amount of generated waterdrops depends on the amount of water present inside a cell.

In contrast, the output depends on a water content of an electrolyte membrane (including electrolyte material of a catalyst layer). Membrane resistance decreases with increasing water content, making ionic migration easier. As a result, the cell voltage improves with higher output. Conversely, if the water content decreases, the output also decreases. The water content also depends on the amount of water present inside a cell.

As a result of earnest analysis, the inventors determined the water content inside a cell and invented an operation map that identifies a safe operation range in which the cell voltage neither drops nor becomes unstable so that a control method by which stable operation according to the map is performed could be proposed.

A first embodiment of the present invention is a fuel cell system, wherein if, in a polymer electrolyte fuel cell having a cell comprising separators sandwiching an electrolyte membrane and electrodes, a temperature (Tmax) at which a standard deviation of a cell voltage begins to increase when water content retained in the cell is increased under conditions under which a cell temperature, a gas entrance dew point, and a current are specified and the temperature (Tmin) at which an average value of the cell voltage begins to drop when the gas dew point is decreased under conditions under which the cell temperature, gas entrance dew point, and current are specified are defined, the water content retained in the cell satisfies: upper limit of a maximum amount of water retained in a cell>water content retained in a cell>lower limit of a maximum amount of water retained in a cell.

When determining Tmax, the standard deviation of a cell voltage and the average value thereof are important. The standard deviation of a cell voltage is a standard deviation determined, for a fuel cell having a plurality of cells, for each cell by measuring the voltage of each cell during electricity generation. The reason why the standard deviation is determined for each cell, instead of the standard deviation of a total voltage of all cells, is that changes in the standard deviation are thereby made more sensitively detectable. The standard deviation is approximately constant at increasing temperature before reaching Tmax and the temperature at which the standard deviation increases by 10% is stipulated as Tmax. In consideration of variations in data, the temperature at which the standard deviation increases by some constant between 50% and 100% with respect to a value when the temperature increases up to Tmax is preferably defined as Tmax. If, as a result, the temperature (Tmax) at which the standard deviation increases is substantially the same as that determined from the standard deviation of all cells, there arises no problem if Tmax is determined from the standard deviation of a total voltage of all cells.

The temperature (Tmin) at which the average value of the cell voltage begins to drop is determined from the average value of voltages of all cells. The extent to which the average value falls is assumed to be a certain value (reference value) of 90% or less with respect to an almost constant value up to Tmin. The temperature when the reference value is reached is defined as Tmin. In consideration of variations in data, it is preferable to define Tmin as a constant between 70% and 90% with respect to the average value up to Tmin.

The water content retained in a cell is stipulated by a water balance calculation from cell startup until a certain electricity generation state (steady electricity generation) is reached.

(Water content retained in a cell)=(integrated value of a water supply in a fuel supply gas)+(integrated value of a water supply in an oxidant supply gas)+(integrated value of generated water)−(integrated value of a water supply in a fuel exhaust gas)−(integrated value of a water supply in an oxidant exhaust gas)+(integrated value of water supplied/discharged via other paths)

Here, the steady state means a state in which the gas flow rate, gas dew point, and cell temperature are substantially constant. The integrated value of a water supply in a fuel supply gas is the total amount of water in a fuel supplied from startup till steady electricity generation. The integrated value of a water supply in an oxidant supply gas is the total amount of water in an oxidant supplied from startup till steady electricity generation. The integrated value of a water supply in a fuel exhaust gas is the total amount of water in a fuel exhaust gas discharged from the cell from startup till steady electricity generation. The integrated value of a water supply in an oxidant exhaust gas is the total amount of water in an oxidant exhaust gas discharged from the cell from startup till steady electricity generation. The integrated value of other released water is a value to be considered if water supplied to the cell from outside is present when, for example, a portion of a coolant is used for humidification. If there is no case in which water is supplied other than gas, this item is deleted. Conversely, if water is discharged via a route other than a gas discharge system, the sign of such an item must be minus.

The water content retained in a cell determined in this manner varies by changing the cell temperature, the gas entrance dew point, or the current. As a result, the temperature on a high-temperature region when the standard deviation of the cell voltage begins to increase is defined as Tmax and the water content retained in a cell at that time becomes the upper limit of the maximum amount of water retained in a cell.

Conversely, the temperature on a low-temperature region when the average cell voltage begins to drop is defined as Tmin and the water content retained in a cell at that time becomes the lower limit of the maximum amount of water retained in a cell.

A second embodiment is a fuel cell system, wherein if the temperature (Tmax) at which the standard deviation of the cell voltage begins to increase when the gas dew point is increased under conditions under which the cell temperature, gas entrance dew point, and current are specified and the temperature (Tmin) at which the average value of the cell voltage begins to drop when the gas dew point is decreased under conditions under which the cell temperature, gas entrance dew point, and current are specified are defined, the gas entrance dew point (water feeding speed to the cell) at startup satisfies: upper limit of the maximum amount of water retained in a cell≧(cell temperature−gas entrance dew point)×gas flow rate×startup time+water generation speed×startup time.

Here, the difference of (cell temperature−gas entrance dew point) represents a value in terms of the amount of water (number of moles) exceeding the number of moles of saturated vapor. If the cell temperature is high, no condensation occurs and the above formula never exceeds the maximum amount of water retained in a cell. Conversely, if the gas entrance dew point is higher than the cell temperature, the value on the right-hand side of the above formula may exceed the maximum amount of water retained in a cell after a certain time passes.

Incidentally, the gas entrance dew point is an amount of water (concentrations denoted in the unit of mol/liter) per volume of gas fed to the cell. Here, the volume of gas is a converted value in a dry state. A gas feeding speed is an amount in terms of flow rate in a dry state and represented in the unit of liter/s. Thus, the product of the difference between the cell temperature and gas entrance dew point in the above formula (that is, a molar concentration of water that can condense inside the cell exceeding the number of moles of saturated vapor) and the gas flow rate (in the unit of liter/s) represents an increasing speed (represented in the unit of mol/s) of water to condense in the cell.

Further, multiplying the startup time yields the amount of water accumulated inside the cell between the start and end of startup. If the cell temperature or the gas entrance dew point is a function of the startup time, (cell temperature−gas entrance dew point)×gas flow rate×startup time is integrated.

The water generation speed is a generation speed of water by electricity starting up and is stipulated by a current. The unit thereof is mol/s. (Water generation speed×startup time) is a value of a time integral of the water generation speed and the unit thereof is mol.

A third embodiment is a fuel cell system provided with a mechanism to control a cell operation method, wherein a difference between a total amount of water in a gas fed to a cell and that in a gas discharged from the cell is within the range of a difference between the maximum amount of water and the amount of water inside the cell in an initial state of operation.

A fourth embodiment is a fuel cell system, wherein the gas entrance dew point when a load changes satisfies: maximum amount of water retained in a cell≧(cell temperature−gas entrance dew point)×gas flow rate×startup time+water generation speed×startup time.

A fifth embodiment is a fuel cell system provided with a mechanism for controlling an electricity generation control method by which Tmax is caused to change by making a coordinated operation to be performed between rate of revolutions (=gas flow rate) of a circulating pump and a gas feed pump and the fuel cell.

A sixth embodiment is a fuel cell system provided with a mechanism for controlling an electricity generation control method by which Tmax is caused to change by making a coordinated operation to be performed between a secondary battery and the fuel cell.

According to the present invention, output improvement of a fuel cell can be combined with voltage stability.

### BRIEF DESCRIPTION OF THE DRAWINGS

FIG. 1 is a fuel cell of the present invention;

FIG. 2 is a decision diagram of a maximum value determined from cell voltage stabilization parameters of the present invention and a decision diagram of a minimum value determined from output control parameters; and

FIG. 3 is a diagram showing an operation map of the present invention.

### DESCRIPTION OF THE PREFERRED EMBODIMENTS

Embodiments of the present invention will be shown to gain effects of the present invention. However, the present invention is not limited to the embodiments shown here.

The first embodiment is realized by an operation map stipulated by parameters described below.

The number of cells in a fuel cell is specific to cell specifications such as the cell output, current, and operating temperature. If the number of cells is determined, the number of separators is also determined and therefore, the volume of a gas passage of the separators and the surface area of the gas passage are determined by the cell specifications. Water accumulated inside the passage while electricity being generated depends on the surface area of the passage because it is attached to the surface of the passage. Water accumulated inside the passage while electricity being generated also depends on the shape of the passage because the ease with which the water is discharged is controlled by the linear velocity (defined as the flow rate/passage cross section) of a gas flowing through the passage. As a result, the probability of occurrence of a passage blockade is specific to the cell specifications.

Various operating parameters for causing the cell to generate electricity exist and control the probability of occurrence of a passage blockade except for the cell specifications. Operating parameters of the cell include voltage stabilization control parameters by a passage blockade and output control parameters by drying of an electrolyte membrane.

First, the former voltage stabilization control parameters will be described.

There is a vapor feeding speed at which vapor is fed to the cell as the first voltage stabilization control parameter. The vapor feeding speed is given as a product of the gas feeding flow rate and the partial vapor pressure in the gas and, if the gas flow rate is fixed, is stipulated by the dew point. A humidified gas containing vapor to some degree is mostly used as a gas to be fed to the cell before electricity generation. Water contained therein changes the amount of water inside the cell and thereby changes the probability of occurrence of a passage blockade. That is, if the gas dew point is high, the probability of occurrence of a passage blockade increases and, conversely if the gas dew point is low, the probability of occurrence of a passage blockade decreases.

There is an operating temperature of the cell as the second voltage stabilization control parameter. This is because the saturated vapor pressure in the gas phase inside the passage changes, leading to variations of the amount of generated waterdrops.

There is gas utilization as the third voltage stabilization control parameter. If the gas utilization of a fuel or an oxidant is low, the amount of unreacted gas increases in an outlet passage of the separators and thus the linear velocity of the gas can be increased, resulting in improved drainage of waterdrops. Consequently, the probability of occurrence of a passage blockade decreases with decreasing gas utilization. Conversely, if the gas utilization increases, the linear velocity of gas in the outlet passage of the separators decreases, leading to a higher probability of occurrence of a passage blockade.

There is a gas circulation speed as the fourth voltage stabilization control parameter. Even if the gas utilization is the same, the gas linear velocity of a reactant gas in the outlet passage can apparently be made faster by a circulation system such as a pump set up outside. If the circulation speed of the gas is increased by the circulation system, the probability of a passage blockade decreases. Conversely, if the circulation speed is decreased, the probability of a passage blockade increases, with the highest probability particularly when the circulation system stops.

Next, the output control parameters by drying of an electrolyte membrane will be described. These parameters are not necessarily independent of the aforementioned voltage stabilization control parameters and, as described later, are mutually interfering parameters. However, there is a difference between both parameters in numerical value ranges in which phenomena of output drops and voltage instability occur.

There is a vapor feeding speed at which vapor is fed to the cell as the first output control parameter. If the vapor feeding speed decreases, the aforementioned probability of occurrence of a passage blockade decreases. However, if the vapor feeding speed further decreases beyond the proper range thereof, drying of an electrolyte membrane proceeds, increasing resistance of the electrolyte membrane. In this respect, the output control parameter may have an opposite effect with respect to voltage stabilization. That is, there is a tendency of less voltage stabilization with higher output values. In a condition where output goes down, there is a tendency that voltage stabilization once improves because the amount of water causing a passage blockade decreases. However, if water causing a passage blockade vanishes and the vapor feeding speed decreases to the extent that drying of the electrolyte membrane proceeds, both output and voltage stabilization may drop. This can be conjectured to be caused by repeated generation of water and drying locally on the electrolyte surface, leading to ununiform distribution of current density in a membrane-electrode assembly.

There is an operating temperature of the cell as the second output control parameter. This parameter is related to the first parameter of the vapor feeding speed (or the gas dew point) and, even if the first parameter is high, the operating temperature of the cell may be still be higher beyond that, making relatively easier for the electrolyte membrane to dry. That is, if the difference between the operating temperature of the cell and the gas dew point increases, output goes down, as a result, due to drying of the electrolyte membrane. Conversely, if the difference becomes smaller, output does not go down.

There is gas utilization as the third output control parameter. If the gas utilization of a fuel or an oxidant is too low, it is advantageous for voltage stabilization, but water is vaporized from the electrolyte membrane, facilitating drying of the membrane. Particularly, if the partial vapor pressure of the gas phase in the outlet passage of the separators is extremely lower than the saturated vapor pressure, the electrolyte membrane is dried due to a balance with the gas dew point. Conversely, if the gas utilization is high, there is a tendency that the partial vapor pressure approaches the saturated vapor pressure and thus, drying of the electrolyte membrane can be prevented and, as a result, output can be inhibited from going down.

As has been described above, operation control parameters including four voltage stabilization control parameters and three output control parameters determine voltage stabilization and output of fuel cells based on each cell specifications.

After organizing these parameters, a method of creating an operation map that can combine voltage stabilization with high output of fuel cells of different specifications will be described.

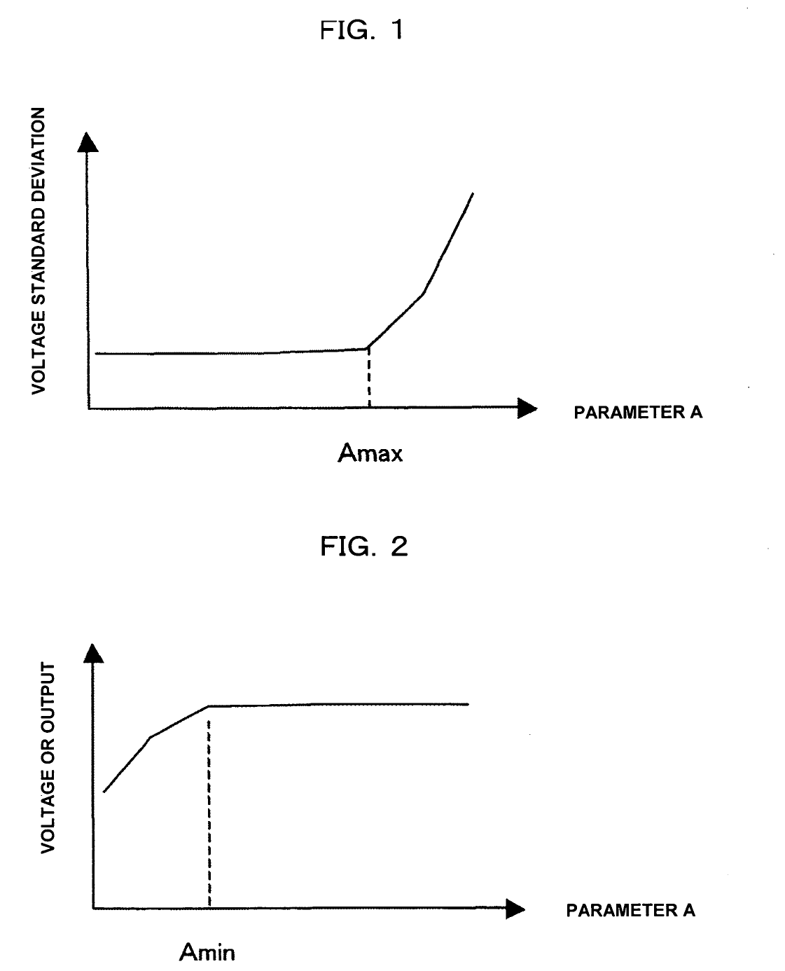

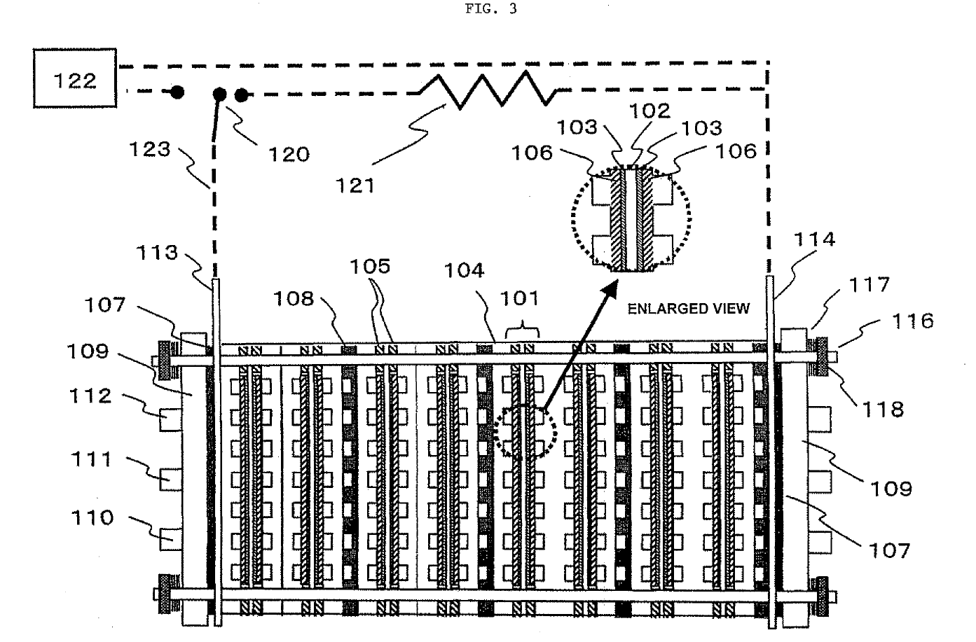

First, a voltage stabilization control parameter or an output control parameter is selected while maintaining other parameters constant. FIG. 1 shows the maximum value defined when the standard deviation of the cell voltage increases by increasing the parameter selected for the present invention. The parameter is a factor that increases dew water in a passage of separators included in a cell to cause a passage blockade when the amount of water exceeds a certain value, destabilizing the voltage. The parameter may be, for example, the gas dew point, current, 1/cell temperature (a reciprocal number of cell temperature), or gas utilization.

FIG. 2 shows the minimum value defined when the entire cell voltage falls by increasing the parameter selected for the present invention. Accordingly, the minimum value of the output control parameter can be determined.

The parameter is a factor that decreases water in an electrolyte membrane in a passage of separators included in a cell to lower the voltage by increased resistance of the membrane when a certain value is exceeded.

With the above basic data, the selected parameter is changed in the positive direction to determine the value at which the voltage begins to become unstable, which is defined as an upper limit Amax. As a criterion for judging that the voltage begins to become unstable, Amax is defined as a value when the voltage increases by a certain ratio from an approximately constant reference value before voltage variations begin to become unstable. The rate of increase to be a criterion differs depending on the level of voltage stabilization required of a cell. That is, a lower rate of increase should be applied to a user requiring high voltage stabilization, but the opposite may also be possible in view of a tradeoff for product costs. It is generally preferable to set the ratio in the range of 10 to 20%.

Next, the parameter value is changed in the negative direction to determine the value at which output begins to go down, which is defined as a lower limit Amin. Also as a criterion for judging that output has fallen, Amin is defined as a value when the output falls by a certain ratio from an approximately constant reference value before the output goes down. It is generally preferable to set a value when the output falls by 10 to 20% from the reference value as Amin.

Amin and Amax of each parameter are determined in this manner, creating an intermediate range of a set of parameters. A portion sandwiched by two sides is a stable operation range. Similarly, intermediate ranges of other parameters are determined. A portion where these three intermediate ranges overlap sets conditions for realizing high-power electricity generation in which the voltage is stable.

The second embodiment is a fuel cell system, wherein if the temperature (Tmax) at which the standard deviation of the cell voltage begins to increase when the gas dew point is increased under conditions under which the cell temperature, gas entrance dew point, and current are specified and the temperature (Tmin) at which the average value of the cell voltage begins to drop when the gas dew point is decreased under conditions under which the cell temperature, gas entrance dew point, and current are specified are defined, the gas entrance dew point (water feeding speed to the cell) at startup satisfies: upper limit of the maximum amount of water retained in a cell≧(cell temperature−gas entrance dew point)×gas flow rate×startup time+water generation speed×startup time. This is an operation condition particularly focusing on voltage stabilization at startup when the gas entrance dew point is selected as the first voltage stabilization control parameter. In this case, the cell temperature is low and generally the lower limit of the maximum amount of water retailed in a cell is rarely reached.

Conversely, in an initial state after startup, a passage blockade is more likely to be caused by dew condensation in a separator passage after a humidified gas being fed into a cell stack or condensation of water generated by electricity generation in a passage.

Thus, if, within the framework of the first embodiment, startup conditions are set so that the maximum amount of water is satisfied, a startup procedure that works around the problem of unstable voltage can be provided. This is the main function of the second embodiment.

More specifically, the upper limit of the fuel gas or oxidant gas dew point is set. The aforementioned Tmax is determined to fix the upper limit and the gas dew point is controlled so that the fuel gas or oxidant gas is equal to or lower than the upper limit.

If the gas dew point varies depending on the cell temperature, the water balance (=supplied water+generated water−discharged water) is measured at each temperature and Tmax and the gas dew point at each temperature are determined from an integral value thereof. Tmax generally follows change of the cell temperature and a temperature difference between them is typically 5 to 10° C. Therefore, the gas dew point may be adjusted so that Tmax is 5 to 10° C. lower compared with the cell temperature pattern. Incidentally, the temperature difference depends on the separator structure of the cell and electricity generation conditions (such as the temperature and gas utilization) and should concretely be measured for each cell. Thus, the second embodiment of the present invention is not limited to the exemplified temperature range (5 to 10° C.).

The third embodiment is a fuel cell system provided with a mechanism to control a cell operation method, wherein a difference between a total amount of water in a gas fed to a cell and that in a gas discharged from the cell is within the range of a difference between the maximum amount of water and the amount of water inside the cell in an initial state of operation. This is a more general form of the control conditions for carrying out the second embodiment.

The fourth embodiment is a fuel cell system, wherein the gas entrance dew point when a load changes satisfies: maximum amount of water retained in a cell≧(cell temperature−gas entrance dew point)×gas flow rate×transition time+water generation speed×startup time. Water accumulates inside the cell not only at startup, but also when a load changes and, if the amount of water exceeds the maximum amount of water, a separator passage blockade occurs. To prevent the separator passage blockade, the gas dew point accompanying load change is stipulated by replacing the startup time in the second embodiment with the transition time so that stable electricity generation can be realized. The transition time is a time required before the cell voltage stabilizes when some load current (LC1) is changed to another load current (LC2). More specifically, the transition time is a time required when the water balance of the cell in the state of LC1 changes that of the in the state of LC2 before the latter stabilizes.

The fifth embodiment is a fuel cell system provided with a function for controlling an electricity generation control method by which Tmax is caused to change by making a coordinated operation to be performed between rate of revolutions (=gas flow rate) of a circulating pump and a gas feed pump and the fuel cell. If the rate of revolutions of the gas feed pump is increased, the gas linear velocity increases in a separator passage, making a passage blockade more unlikely. Thus, the gas dew point can be increased to a higher value, which is an effective means when a passage blockade is likely to occur at startup or when the load changes.

The sixth embodiment is a fuel cell system provided with a function for controlling an electricity generation control method by which Tmax is caused to change by making a coordinated operation to be performed between a secondary battery and the fuel cell. This is intended to relatively lower electric power of a polymer electrolyte fuel cell by supplying electric power to an external load from the secondary battery when the voltage temporarily becomes unstable. The sixth embodiment has a function to prevent a passage blockade by lowering electric power of the fuel cell to temporarily lower gas utilization. Therefore, the sixth embodiment is particularly effective for a system in which an external load and a secondary battery, and an external load and a fuel cell are connected in parallel via an electronic control circuit including an inverter, a converter, or the like.

What is claimed is:

1. A fuel cell system, wherein if, in a polymer electrolyte fuel cell having a cell comprising separators sandwiching an electrolyte membrane and electrodes, a temperature (Tmax) at which a standard deviation of a cell voltage begins to increase when water content retained in the cell is increased under conditions under which a cell temperature, a gas entrance dew point, and a current are specified and the temperature (Tmin) at which an average value of the cell voltage begins to drop when the gas dew point is decreased under conditions under which the cell temperature, gas entrance dew point, and current are specified are defined, the water content retained in the cell satisfies: upper limit of a maximum amount of water retained in a cell≧water content retained in a cell≧lower limit of a maximum amount of water retained in a cell.

2. The fuel cell system according to claim 1, wherein if the temperature (Tmax) at which the standard deviation of the cell voltage begins to increase when the gas dew point is increased under conditions under which the cell temperature, gas entrance dew point, and current are specified and the temperature (Tmin) at which the average value of the cell voltage begins to drop when the gas dew point is decreased under conditions under which the cell temperature, gas entrance dew point, and current are specified are defined, the gas entrance dew point (water feeding speed to the cell) at startup satisfies: upper limit of the maximum amount of water retained in a cell≧(cell temperature−gas entrance dew point)×gas flow rate×startup time+water generation speed×startup time.

3. The fuel cell system according to claim 1 provided with a mechanism for controlling a cell operation method, wherein a difference between a total amount of water in a gas fed to a cell and that in a gas discharged from the cell is within a range of a difference between the maximum amount of water and the amount of water inside the cell in an initial state of operation.

4. The fuel cell system according to claim 1, wherein the gas entrance dew point when a load changes satisfies: maximum amount of water retained in a cell≧(cell temperature−gas entrance dew point)×gas flow rate×transition time+water generation speed×startup time.

5. The fuel cell system according to claim 1, comprising a mechanism for controlling an electricity generation control method by which Tmax is caused to change by making a coordinated operation to be performed between numbers of revolutions (=gas flow rate) of a circulating pump and a gas feed pump and the fuel cell.

6. The fuel cell system according to claim 2, comprising a mechanism for controlling an electricity generation control method by which Tmax is caused to change by making a coordinated operation to be performed between rate of revolutions (=gas flow rate) of a circulating pump and a gas feed pump and the fuel cell.

7. The fuel cell system according to claim 1, comprising a mechanism for controlling an electricity generation control method by which Tmax is caused to change by making a coordinated operation to be performed between a charge to a secondary battery and the fuel cell.
